(19) United States
(12) Patent Application Publication
(10) Pub. No.: US 2016/0295477 A1
(43) Pub. Date: Oct. 6, 2016

(54) Network-Assisted Mobility Management Using Multiple Radio Access Technologies

(71) Applicant: INTEL CORPORATION, Santa Clara, CA (US)

(72) Inventor: JING ZHU, Portland, OR (US)

(73) Assignee: INTEL CORPORATION, Santa Clara, CA (US)

(21) Appl. No.: 15/038,397

(22) PCT Filed: Dec. 20, 2013
(86) PCT No.: PCT/US2013/076783

§ 371 Date: May 20, 2016

(51) Int. Cl. H04W 36/14; H04L 12/46; H04W 36/30

(52) U.S. Cl. CPC H04W 36/14; H04W 36/30; H04L 12/4641; H04W 84/045

(57) ABSTRACT

Technology for a cellular base station (BS) in a multiple radio access technology (multi-RAT) heterogeneous network (HetNet) to communicate with a virtual access network (VAN) client is described. A desired VAN server can be determined from a plurality of VAN servers for a VAN client to communicate with. A VAN client that the VAN server is in communication with is determined. A VAN server notification is sent to the VAN client when the VAN client is in communication with a different VAN server than the desired VAN server.

### BACKGROUND

Mobile device users often use their devices to receive multimedia content such as streaming audio, video, data, etc., from a communications node. Mobile computing devices, such as a laptop, a smartphone, an ultrabook, a tablet, or other type of mobile computing device are increasingly equipped with multiple transceivers that support different Radio Access Technologies (RATs), such as Wi-Fi and Cellular transceivers. Virtual Access Network (VAN) technologies allows seamless end-to-end integration of multiple heterogeneous radio access networks (RANs) and enables advanced multi-radio resource management techniques for flow mobility management.

### BRIEF DESCRIPTION OF THE DRAWINGS

Features and advantages of the disclosure will be apparent from the detailed description which follows, taken in conjunction with the accompanying drawings, which together illustrate, by way of example, features of the disclosure; and, wherein:

FIG. 1 depicts a VAN client, a wireless fidelity station, and a cellular user equipment (UE) co-located at a user device in accordance with an example;

FIG. 2 illustrates one embodiment of an integrated multi-RAN protocol stack in accordance with an example;

FIGS. 3a and 3b illustrate embodiments of an integrated multi-RAN architectures in accordance with an example;

FIG. 4 depicts a diagram a cellular base station (BS) in a multi-RAT HetNet that is operable to communicate with a VAN client in accordance with an example;

FIG. 5 depicts a diagram another embodiment of a cellular BS in a multi-RAT HetNet that is operable to communicate with a VAN client in accordance with an example.

FIG. 6 depicts a diagram of a RAN absence notification being sent over a VAN interface in accordance with an example;

FIG. 7 depicts a diagram of another embodiment of a RAN absence notification being sent over a VAN interface in accordance with an example;

FIG. 8 depicts functionality of computer circuitry of cellular BS in a multi-RAT HetNet that is operable to communicate with a VAN client in accordance with an example;

FIG. 9 depicts functionality of computer circuitry of a UE in a multi-RAT HetNet that is operable to communicate with a VAN server in accordance with an example;

FIG. 10 illustrates a method of switching between frequency bands in a multi-RAT heterogeneous network HetNet in accordance with an example;

FIG. 11 depicts functionality of computer circuitry of a VAN server that is operable to communicate with a VAN client in a multi-RAT HetNet in accordance with an example; and

FIG. 12 illustrates a diagram of a user equipment (UE) in accordance with an example.

Reference will now be made to the exemplary embodiments illustrated, and specific language will be used herein to describe the same. It will nevertheless be understood that no limitation of the scope of the invention is thereby intended.

### DETAILED DESCRIPTION

Before the present invention is disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular examples only and is not intended to be limiting. The same reference numerals in different drawings represent the same element. Numbers provided in flow charts and processes are provided for clarity in illustrating steps and operations and do not necessarily indicate a particular order or sequence.

Virtual Access Network (VAN) technologies allows seamless end-to-end integration of multiple heterogeneous radio access networks (RANs) and/or Radio Access Technologies (RATs) and enables advanced multi-radio resource management techniques, such as seamless offload, flow mobility, bandwidth aggregation, load balancing, and so forth.

Flow mobility management allows moving selected data flows, such as data flows from a selected UE, from one RAN or RAT to another. For example, the data flows may be moved during the middle of a session, without any interruptions, while keeping other flows on the current network. Multi-radio network selection and flow mobility decisions are usually made by the VAN client.

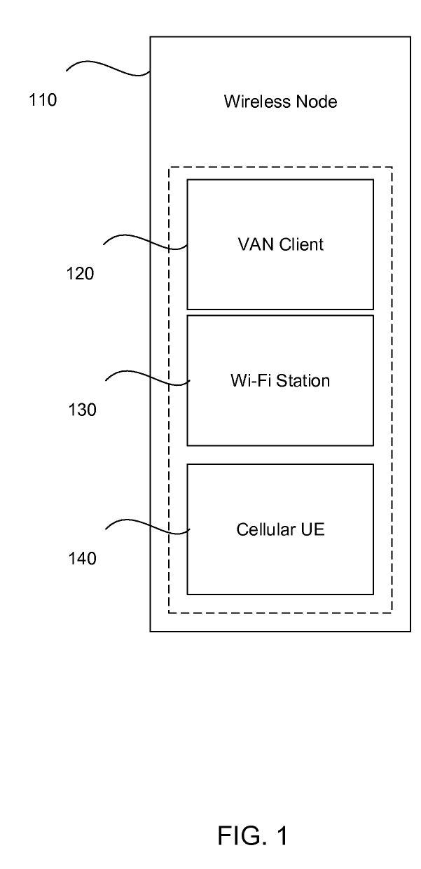

FIG. 1 illustrates one embodiment of where a VAN client 120, a wireless fidelity (Wi-Fi) station 130, and a UE 140 are co-located at a wireless node 110.

In one embodiment, a RAT may comprise a RAN, which may be an access network that operates on a specified radio frequency band. The specified radio frequency band may be a licensed band, such as a cellular band used in a wireless wide area network (WWAN). Selected WWAN standards include the third generation partnership project (3GPP) long term evolution (LTE), Releases 8, 9, 10 or 11, and the institute of electrical and electronics engineers (IEEE) 802.16-2012 standard, commonly referred to as WiMAX. Alternatively, the specified radio frequency band may be a in an unlicensed band used in a wireless local area network (WLAN). Selected WLAN standards include the IEEE 802.11 or IEEE 80211ac standard, the IEEE 802.15 standard, the Bluetooth standard, and so forth. The WLAN standards and the WWAN standards are typically not interoperable and are considered to be different RATs.

The term cellular network and cellular base station are used throughout the specification. The terms are not intended to be limiting. The cellular network may be any kind of WWAN network. Similarly, the cellular BS can be any kind of WWAN node, such as an IEEE 802.16-2012 BS, or a 3GPP LTE Rel. 8, 9, 10 or 11 eNB.

In one embodiment, a multi-RAT HetNet can be comprised of one or more cellular network nodes and one or more Institute of Electrical and Electronics Engineers (IEEE) 802.11-2012 configured access points. In one embodiment, the one or more WWAN standards may be 3GPP LTE Rel. 8, 9, 10, 11, or 12 networks and/or IEEE 802.16p, 802.16n, 802.16m-2011, 802.16h-2010, 802.16j-2009, 802.16-2009 networks. In one embodiment, the RATs used may include a multiple different RATs, such as 3GPP RATs, WLAN RATs, mm-wave RATs, D2D RATs, 60 GHz RATs, etc.

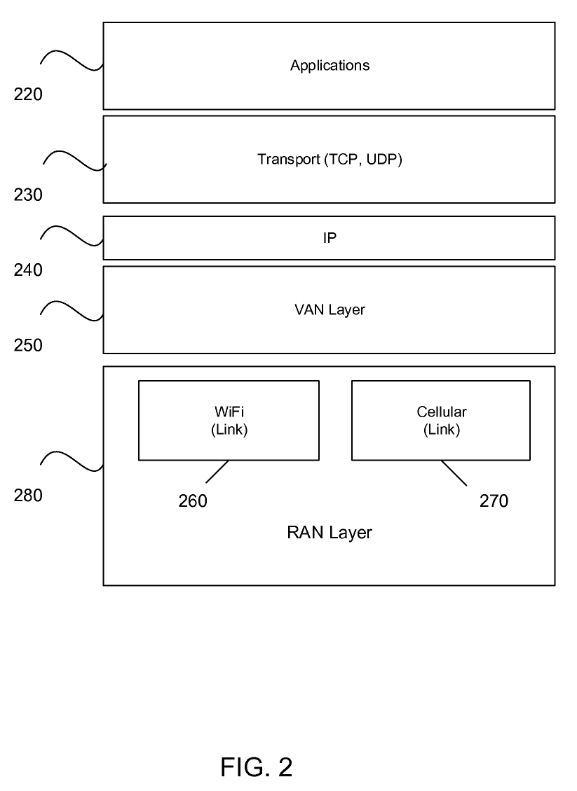

FIG. 2 illustrates one embodiment of an integrated multi-RAN protocol stack 210. In one embodiment as illustrated in FIG. 2, the integrated multi-RAN protocol stack 210 comprises an applications layer 220, a transport layer 230 such as a transmission control protocol (TCP) or a user datagram protocol (UDP), an internet protocol (IP) layer 240, a VAN layer 250, and a RAN layer 280. In one embodiment, the RAN layer 280 comprises a wireless fidelity (Wi-Fi) link 260 and a cellular link 270

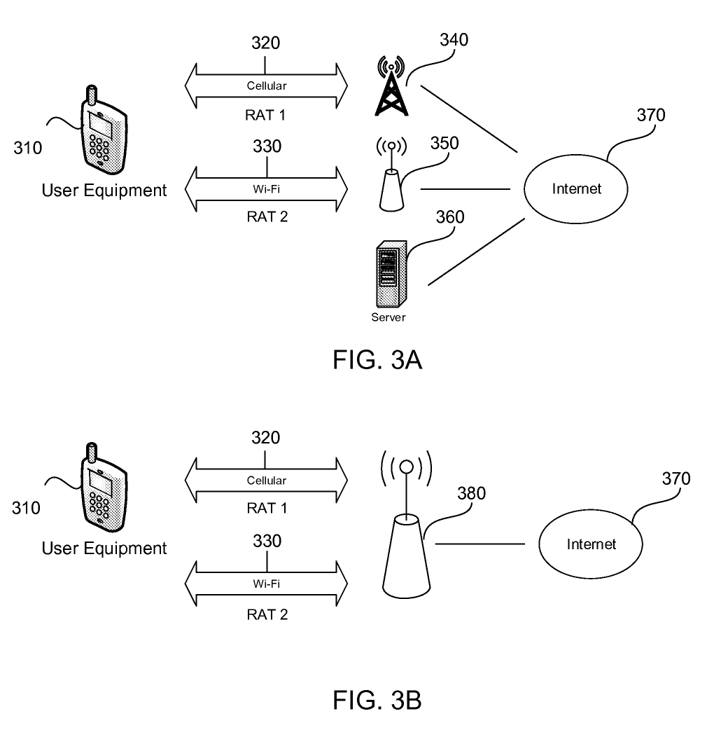

FIGS. 3a and 3b illustrate embodiments of an integrated multi-RAN architecture. In FIG. 3a user equipment (UE) 310 connects to the internet 370 using a cellular base station (BS) 340 via a RAT 1 320, such as a cellular RAN connection, and/or using a Wi-Fi access point (AP) 350 via a RAT 2 330, such as a Wi-Fi RAN connection. FIG. 3a further illustrates that in one embodiment the VAN server 360 may not be co-located with the Wi-Fi AP 350 and the cellular BS 340. In one embodiment as illustrated in the example of FIG. 3b, the VAN server, Wi-Fi AP, and the cellular BS can be collocated at a node 380. The UE 310 in FIG. 3b can perform substantially similar as previously described with respect to the UE in FIG. 3a.

In one embodiment, a Virtual Access Network (VAN) may be an access network that operates Over-The-Top of one or multiple RANs using the tunneling protocols such as Mobile IP or virtual private network (VPN). In another embodiment, a VAN may operate over multiple RANs directly, such as when VAN server, Wi-Fi AP, and Cellular BS are co-located as shown in FIG. 3b.

In one embodiment, an access network is a client-server based network in which the server provides internet protocol version 4 (IPv4) or internet protocol version 6 (IPv6) address to the client for internet access.

In determining flow mobility, it can be desirable for a UE to switch from a VAN server that the UE is currently attached to or communicating with to a different VAN server, such as a VAN server that is closer in proximity or co-located with a serving cellular BS. In one embodiment, a cellular BS, such as an evolved Node B (eNB) can provide a list of recommended VAN servers to a UE so that the UE's co-located VAN client may detach from its serving VAN server to a VAN server with a better location or better connection with the UE. In one embodiment, a user device, cellular UE, Wi-Fi STA, Wi-Fi AP, and cellular BS may operate in an unlicensed or licensed spectrum.

In one embodiment, for a UE to switch from a connection with one VAN server to another VAN server, the serving Cellular BS will first select a desired VAN server from a pre-defined VAN server list. In one embodiment, the desired VAN server is the VAN server that is co-located with the serving Cellular BS. In another embodiment, the desired VAN server is the VAN server that is not co-located with the serving Cellular BS. In one embodiment, the desired VAN server is the VAN server with a lowest latency or highest throughput rates between the VAN server and the serving Cellular BS. In one embodiment, the list of available VAN servers is preconfigured. In one embodiment where the local VAN server is not available, there is a list of remote VAN servers. In one embodiment, when only multiple remote servers are available, the cellular BS can ping each remote server to measure the latency between the BS and the remote server, measure the response time, and then select the VAN server with the lowest latency time. In another embodiment, the cellular BS can probe each of the VAN servers to measure data throughput between the cellular BS and the VAN server.

In one embodiment, after selecting a desired VAN server, the serving Cellular BS may then determine if a UE is already attached to the desired VAN server. In one embodiment, the cellular BS may determine if the UE is attached to the desired VAN server by inspecting the destination IP address and port number of packets received from the UE. If the UE is not attached to the desired VAN server, the cellular BS can send VAN Server Notification information to the UE. In one embodiment, the cellular BS can be small cell BS. This will be discussed more fully in the proceeding paragraphs.

In one embodiment, the VAN server notification may include: the type of VAN technology; the internet protocol (IP) address, such as an IPv4 address or an IPv6 address, of the desired VAN server; the port number or range of port numbers of the desired VAN server; and a co-location indicator. In one embodiment, the VAN technology type may be a dual stack mobile internet protocol version 6 (DSMIPV6) or a vendor-specific VAN solution. In one embodiment, the co-location indicator can indicate whether the VAN server is co-located with the cellular BS. When the co-location indicator is set to 1, the VAN server can be co-located with the cellular BS and when the co-location indicator is set to 0 the VAN server can be not co-located with the cellular BS, or vice-versa.

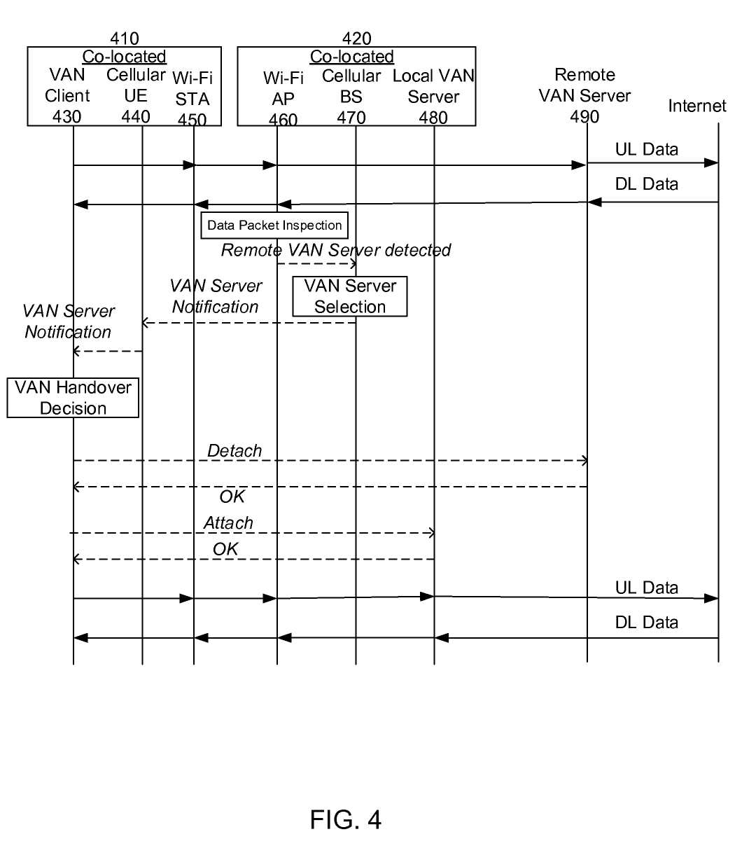

FIG. 4 shows a diagram of one embodiment of a cellular BS in a multi-RAT HetNet that is operable to communicate with a VAN client. In FIG. 4, the VAN client 430, Cellular UE 440, and

Wi-Fi Station (STA) 450 are co-located at a mobile wireless device 410. In FIG. 4, the Wi-Fi AP 460, Cellular BS 470, and Local VAN server 480 are co-located in the communications system 420. In FIG. 4, the VAN client 430 is in communication with the Wi-Fi AP 460 via a Wi-Fi STA 450 to relay uplink and downlink data through a remote VAN server 490 to and from the internet. While the VAN client 430 is in communicating with the W-Fi AP 460, the Wi-Fi AP 460 will analyze the data packets in the data flow to determine which VAN server the VAN client 430 is connected with. After the data packets are analyzed, a cellular BS 470 will determine if the VAN client 430 is in communication with desirable desired VAN server.

In one embodiment as illustrated in the example of FIG. 4, the desired VAN server can be the local VAN server 480 that is co-located with the cellular BS 470 and the Wi-Fi AP 460. In another embodiment, the desired VAN server may not be co-located with the cellular BS 470 and the Wi-Fi AP 460. In one embodiment, if the cellular BS 470 determines that the VAN client 430 is not connected with the desired VAN server, then the cellular BS 470 will communicate to the VAN client 430 a VAN server notification. The VAN client 430 will determine whether to detach from the currently serving Remote VAN Server 490. When the VAN client 430 determines to switch to the desired VAN server 480, the VAN client 430 will send a detachment request to the Remote VAN server 490 and the VAN client 430 will receive a detachment acknowledgement from the VAN server 490. When the VAN client 430 receives the detachment acknowledgement, the VAN client 430 will detach from the currently serving VAN server 490. When the VAN client 430 has detached from the serving VAN server 490, the VAN client 430 will send an attachment request to the Local VAN Server 480 and the VAN client 430 will receive an attachment acknowledgement from the Local VAN Server 480. When the VAN client 430 receives the attachment acknowledgement, the VAN client 430 will attach to the Local VAN server 490. When the VAN client 430 has attached to the desired VAN server 480, the VAN client 430 can communicate with the Wi-Fi AP 460 via a Wi-Fi STA 450 to a relay uplink and downlink data through a local VAN server 480 to and from the internet. In one embodiment, the Cellular UE 440 can be in communication with a Cellular BS 470 to further communicate that the VAN server notification may be sent over a cellular air-interface directly using, for example, radio resource control (RRC) messages. Then, the cellular UE 440 can forward VAN server notification to the co-located VAN client 430.

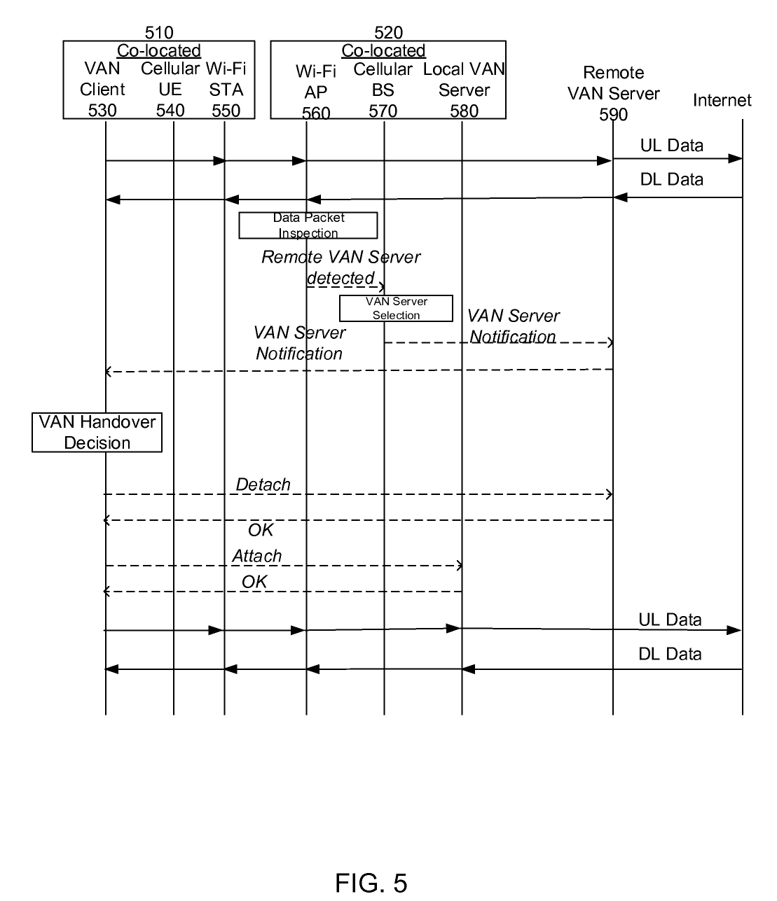

FIG. 5 shows another embodiment of the cellular BS 570 in a multi-RAT HetNet that is operable to communicate with a VAN client 530. FIG. 5 depicts a VAN-based switch over of a VAN client 530 to a different VAN server. In this embodiment, the cellular BS 570 communicates the VAN server notification to the remote VAN server 590 and the remote VAN server 590 communicates the VAN server notification to the VAN client 530 using VAN control messages. In one embodiment, the VAN server notification may be sent from Remote VAN server 590 to the VAN client 530 using a virtual assess layer. The remaining steps depicted in FIG. 5 are substantially similar to those of FIG. 4.

In one embodiment, after receiving the VAN Server Notification information, the VAN client can detach from its currently serving VAN server, and attach to a recommended VAN Server. In one embodiment, VAN client switching depends on if there is ongoing traffic. For example, whenever switching occurs when there is ongoing traffic then the traffic flow may be disturbed. When there is lower traffic, a pause in the traffic, or no traffic, such as when the VAN client is in an idle state, the VAN client can switch to a recommended VAN server with minimal or no disturbance to the traffic flow.

In addition to attaching to the desired VAN server, it may be desirable to switch frequency bands when there is interference on the frequency band being used by a user device, UE, Wi-Fi STA, or other type of wireless device. In one embodiment, a user device, UE, Wi-Fi STA, Wi-Fi AP, and BS may be configured to communicate in a licensed or unlicensed spectrum. The interference on frequency bands may increase as the number of small cells in a multi-RAT HetNet increases. Small cells are low-power wireless access points that operate in a licensed spectrum. Small cells may provide improved cellular coverage, capacity, and applications for homes and enterprises as well as metropolitan and rural public spaces. In one embodiment, small cells may include, femtocells, picocells, metrocells, microcells, and Home eNode Bs. Small cells may also be used in multi-RAT networks in a multi-RAT HetNet.

When interference among these small cells becomes an issue, the Wi-Fi AP or cellular BS may decide to switch to another frequency band. To avoid disrupting ongoing data sessions, the Cellular BS can send out a RAN absence notification prior to channel switching so that the VAN client can perform the flow mobility or inter-RAT handover operation to move user's traffic seamlessly to another RAN.

In one embodiment, the RAN absence notification may include the following information: an absence starting time, an absence duration, an absence reason, the type of the RAN that will be absent, an identification of the RAN that will be absent, or other relevant information. In one embodiment, the reason for absence may be the channel switching of a Wi-Fi AP or a cellular BS. In another embodiment, the type of RAN that will be absent may be a WLAN RAN such as a Wi-Fi RAN or a WWAN RAN such as a cellular RAN. In one embodiment, the multi-RAT HetNet can be comprised of one or more cellular network nodes and one or more Institute of Electrical and Electronics Engineers (IEEE) 802.11-2012 configured access points. In one embodiment, the identification of the RAN that will be absent may be a Wi-Fi identification such as a service set identifier (SSID) or a basic service set identifier (BSSID). In one embodiment, the identification of the RAN that will be absent may be a cellular RAN identification such as a cell identification (ID). In another embodiment, the other relevant information may include a new operational channel, frequency, or band that the RAN will use.

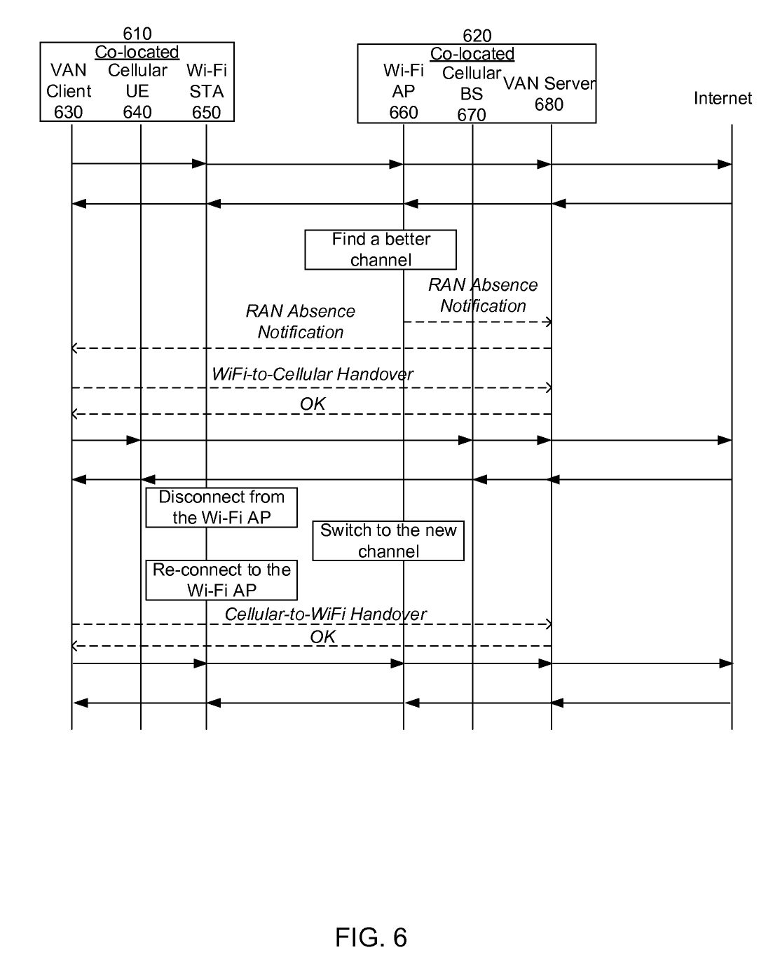

The RAN absence notification may be sent over a VAN interface or over a RAN interface. FIG. 6 shows an example diagram of a RAN absence notification being sent over a VAN interface. In FIG. 6, the VAN client 630, Cellular UE 640, and Wi-Fi Station (STA) 650 are co-located at a user device 610. The Wi-Fi AP 660, Cellular BS 670, and VAN server 680 are co-located in the communications system 620. The VAN client 630 is in communication with the Wi-Fi AP 660 via a Wi-Fi STA 650 to relay uplink and downlink data through a VAN server 680 to and from the internet. In one embodiment as shown in FIG. 6, the Wi-Fi AP 660 can determine to switch to a different frequency band. In another embodiment, the cellular BS 670 can determine to switch to a different frequency band. In one embodiment, the Wi-Fi AP 660 or the cellular BS 670 may determine to switch to a different frequency band based on the level of interference in the band that the Wi-Fi AP 660 or cellular BS 670 is currently using. In the embodiment shown in FIG. 6, when the Wi-Fi AP 660 determines to switch to a different frequency band, the Wi-Fi AP 660 sends a RAN absence notification to the VAN server 680 and the VAN server 680 relays the RAN absence notification to the VAN client 630.

In one embodiment the VAN client 630 may send a request to the VAN server 680 to perform a Wi-Fi to cellular handover procedure or a cellular to Wi-Fi handover procedure. When the VAN server 680 approves a Wi-Fi to cellular handover procedure, the Wi-Fi STA 650 will disconnect from the Wi-Fi AP 660. When the Wi-Fi STA 650 disconnects from the Wi-Fi AP 660, the VAN client 630 will connect to a cellular network, if the VAN client 630 is not currently connected to the cellular network. The VAN client 630 will work together with the VAN server 680 to move the traffic of the VAN client 630 from a Wi-Fi network to a cellular network. The Wi-Fi AP 660 may then switch to a new or different frequency band and the Wi-Fi STA 650 may reconnect with the Wi-Fi AP 660 on the new or different frequency band. In one embodiment, the Wi-Fi STA 650 may reconnect with the Wi-Fi AP 660, and the Cellular UE 640 can disconnect from the cellular network or remain connected to the cellular network. The VAN client 630 will work together with the VAN server 680 to move the traffic of the VAN client 630 from cellular network back to Wi-Fi network.

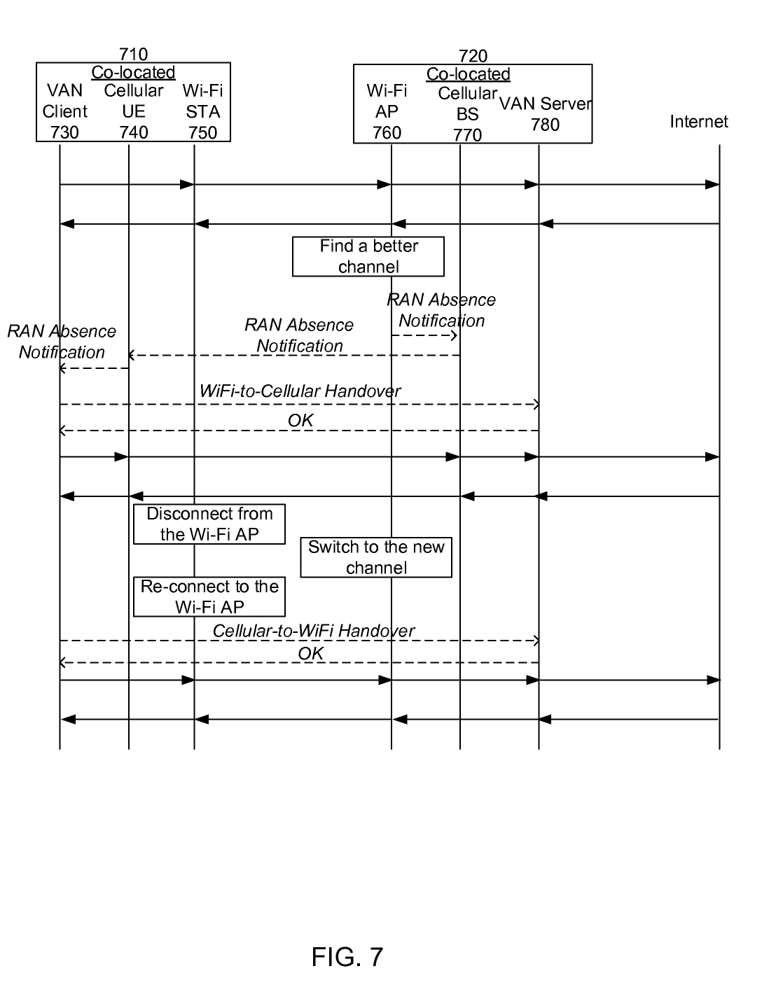

FIG. 7 depicts another embodiment of the sending a RAN absence notification, where the RAN absence notification being sent over a cellular interface. In FIG. 7, when the Wi-Fi AP 760 determines to switch to a different frequency band, the Wi-Fi AP 760 sends a RAN absence notification to the cellular BS 770 and the cellular BS 770 relays the RAN absence notification to the VAN client 730. The remaining steps depicted in FIG. 7 are substantially similar to those of FIG. 6.

In one embodiment, the sending of a RAN absence notification is triggered by the Wi-Fi AP or the cellular BS's determination that the AP or BS will not be available (i.e. absent) for a selected period of time. The unavailability of the AP or BS may be caused by band switching, channel switching, channel interference, a hardware update, a firmware update, and/or a software update. When the VAN client receives the RAN absence notification, the VAN client determines whether to disconnect or detach from the RAN that the VAN client is currently in communication with. One advantage of the VAN client receiving an absence notification is that the user device is informed ahead of time that the Wi-Fi AP or the cellular BS will be absent. Where the user device is informed ahead of time, the user device may switch to a new RAN before the Wi-Fi AP or the cellular BS becomes absent, thus avoiding any disruption in traffic flow or data communications. In one embodiment, when the VAN client determines to disconnect or detach the RAN, the VAN client will then move its traffic over to another RAN.

In one embodiment, after the Wi-Fi AP or the cellular BS completes switching to a new channel, the Wi-Fi AP or the Cellular BS can be configured to reconnect with the VAN server. In one embodiment, when the Wi-Fi AP or the Cellular BS has completed switching to a new channel, the VAN client can re-establish a connection with the initial RAN and move the traffic flow back to the initial RAN. In another embodiment, when the Wi-Fi AP or the Cellular BS completes switching, the VAN client can re-establish a connection with the initial RAN and keeps the traffic flow with the other RAN. In another embodiment, when the Wi-Fi AP or the Cellular BS complete switching, the VAN client can maintain a connection on the channel with the other RAN and does not re-establish a connection with the initial RAN.

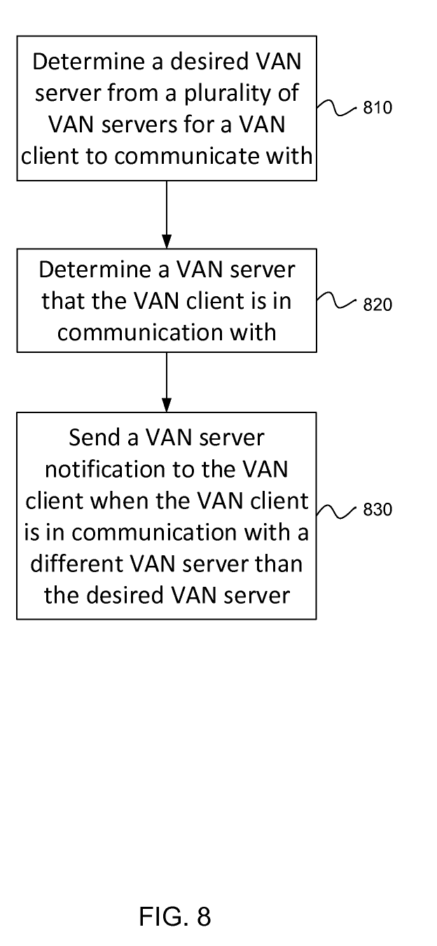

FIG. 8 uses a flow chart to illustrate the functionality of one embodiment of the of the computer circuitry of a cellular BS in a multi-RAT HetNet that is operable to communicate with a VAN client. The functionality may be implemented as a method or the functionality may be executed as instructions on a machine, where the instructions are included on at least one computer readable medium or one non-transitory machine readable storage medium. The computer circuitry can be configured to determine a desired VAN server from a plurality of VAN servers for a VAN client to communicate with, as in block 810. In one embodiment, the desired VAN server is determined based on a latency or throughput between the cellular BS and a remote VAN server. The computer circuitry can be further configured to determine a VAN server that the VAN client is in communication with, as in block 820. The computer circuitry can also be configured to send a VAN server notification to the VAN client when the VAN client is in communication with a different VAN server than the desired VAN server, as in block 830.

In one embodiment, the desired VAN server is co-located with the cellular BS. In another embodiment, the VAN client may be a mobile internet protocol (IP) client or a virtual private network (VPN) client. In another embodiment, the VAN servers may be mobile IP servers, IP home agents, or a VPN server. In another embodiment, the cellular BS may send the VAN server notification to the VAN client using a radio resource control (RRC) message over a cellular air-interface. In one embodiment, the cellular BS is further configured to send the VAN server notification to the VAN client via the currently serving VAN server using a VAN control message. In one embodiment, the cellular BS is further configured to determine a remote VAN server that the VAN client is in communication with by analyzing a destination internet protocol (IP) address and port number of packets received from a user equipment (UE) on which the VAN client operates

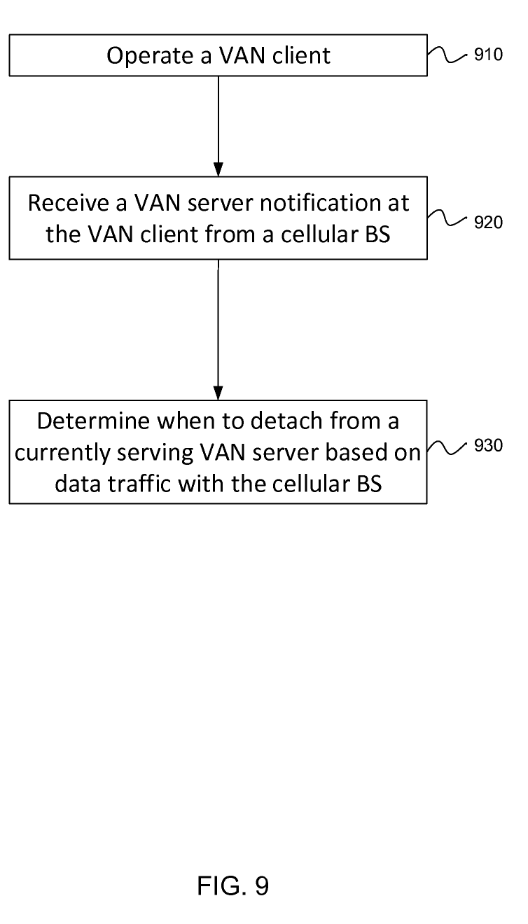

FIG. 9 uses a flow chart to illustrate the functionality of one embodiment of the of the computer circuitry of a UE in a multi-RAT HetNet that is operable to communicate with a VAN server. The functionality may be implemented as a method or the functionality may be executed as instructions on a machine, where the instructions are included on at least one computer readable medium or one non-transitory machine readable storage medium. The computer circuitry can be configured to operate a VAN client, as in block 910. The computer circuitry can be further configured to receive a VAN server notification at the VAN client from a cellular base station (BS), as in block 920. In one embodiment, the VAN server notification identifies a desired VAN server for the VAN client to communicate with. The computer circuitry can also be configured to determine when to detach from a currently serving VAN server based on data traffic with the cellular BS, as in block 930. In one embodiment, the computer circuitry configured to detach from the currently serving VAN server and attach to the desired VAN server provided in the VAN server notification. In one embodiment, when the computer circuitry determines to detach from the currently serving VAN server, the computer circuitry sends a detachment request to the currently serving VAN server and receives a detachment approval from the currently serving VAN server. In another embodiment when the computer circuitry determines to attach, the computer circuitry sends an attachment request to the desired VAN server and receives an attachment approval from the desired VAN server.

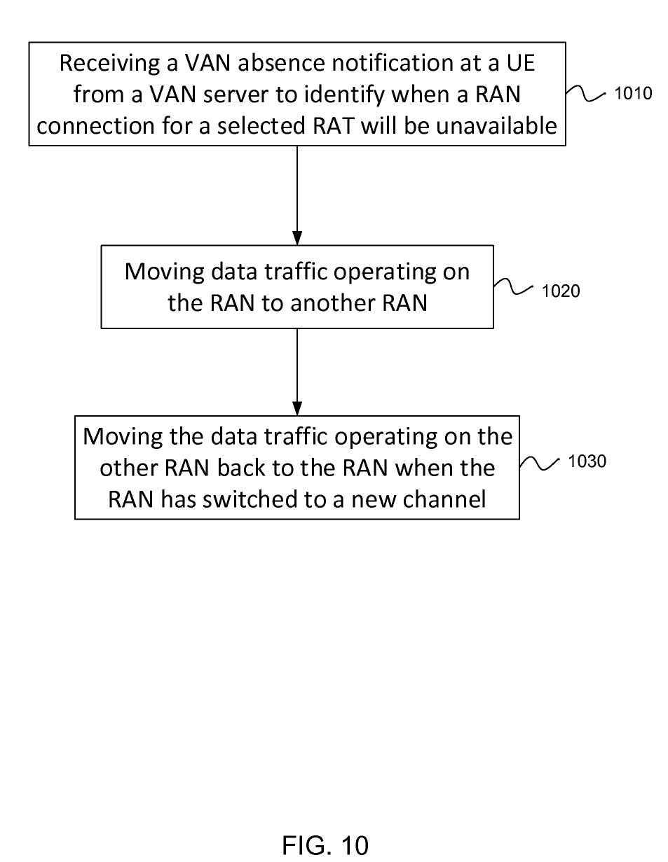

FIG. 10 provides a flow chart to illustrate a method of switching between frequency bands in a multi-RAT heterogeneous network HetNet. The method may comprise receiving a VAN absence notification at a UE from a VAN server to identify when a RAN connection for a selected RAT will be unavailable, as in block 1010. The method may further comprise moving the data traffic operating on the RAN to another RAN, as in block 1020. In one embodiment, the moving the data traffic further comprises moving the data traffic operating on the RAN from a cellular BS to another cellular BS, from a cellular BS to an electrical engineers (IEEE) 802.11-2012, 802.11ac, or 802.11ad configured AP, from a IEEE 802.11-2012, 802.11ac, or 802.11ad configured AP to the cellular BS, or from a IEEE 802.11-2012, 802.11ac, or 802.11ad configured AP to another IEEE 802.11-2012, 802.11ac, or 802.11ad configured AP. In another embodiment, moving data traffic operating on the RAN to other RAN further comprises sending a RAN handover request to the RAN network and receiving a RAN handover approval from the RAN network. The method may further comprise moving the data traffic operating on the other RAN back to the RAN when the RAN has switched to a new channel, as in block 1030.

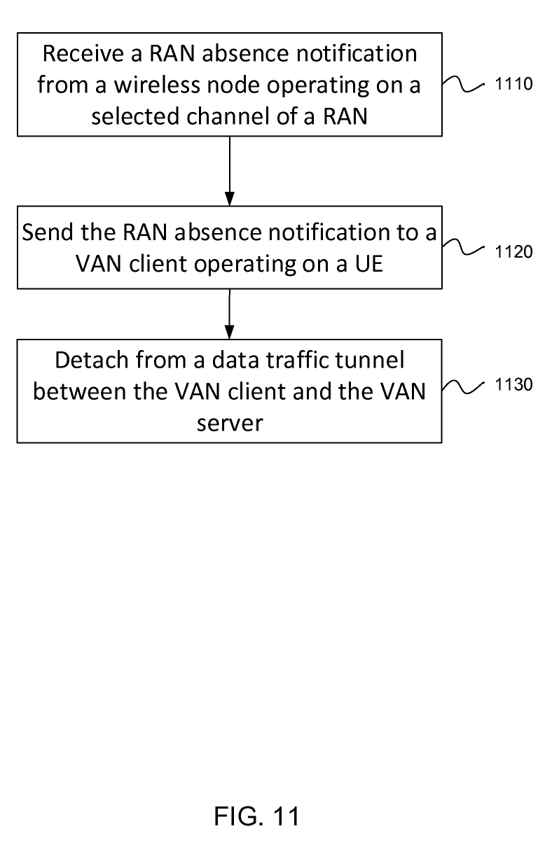

FIG. 11 uses a flow chart to illustrate the functionality of one embodiment of the of the computer circuitry of a VAN server that is operable to communicate with a VAN client in a multi-RAT HetNet. The functionality may be implemented as a method or the functionality may be executed as instructions on a machine, where the instructions are included on at least one computer readable medium or one non-transitory machine readable storage medium. In one embodiment, the computer circuitry may be configured to receive a RAN absence notification from a wireless node operating on a selected channel of a RAN, as in block 1110. In one embodiment, the RAN absence notification further comprises an absence starting time, an absence duration, an absence reason, a RAN type that will be absent, a RAN identification (ID) for the RAN that will be absent, or an operational channel that the RAN will use after switching communication channels. In another embodiment the RAN ID comprises a service set identification (SSID), a basic service set identification (BSSID), or a cellular identification (Cell ID). In one embodiment, the absence reason may include channel switching, a hardware update, a firmware update, and/or a software update.

The computer circuitry can be further configured to send the RAN absence notification to a VAN client operating on a UE, as in block 1120. In one embodiment, the computer circuitry is further configured to send the RAN absence notification based on an absence indication indicating the absence of a Wi-Fi AP or a cellular BS. The computer circuitry may also be configured to detach from a data traffic link between the VAN client and the VAN server, as in block 1130. The date traffic link can include wired and/or wireless portions between the VAN client and the VAN server. In one embodiment, the computer circuitry is further configured to attach to the data traffic link after the RAN has switched to a new channel. In one embodiment, the computer circuitry is further configured to receive a handover request from the VAN client to move data traffic operating on the RAN, when a signal interference level exceeds a defined threshold, and send a handover approval to the VAN client. In another embodiment, the computer circuitry is further configured to receive a handover request to move the data traffic back from another RAN to the RAN when a communication channel on the RAN has switched back to the selected channel and send a handover approval to move the data traffic back from the other RAN to the selected channel on the RAN. The computer circuitry may reattach or switch back to the selected channel on the RAN.

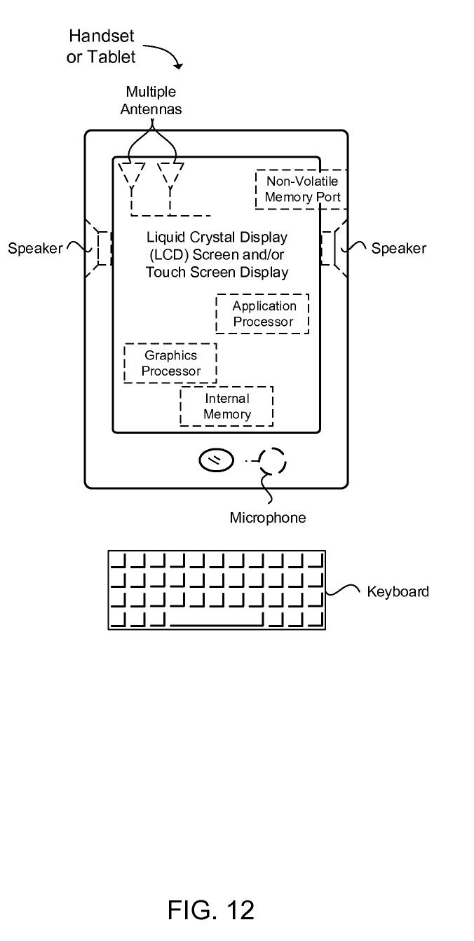

FIG. 12 provides an example illustration of the wireless device, such as a user equipment (UE), a mobile station (MS), a mobile wireless device, a mobile communication device, a tablet, a handset, or other type of wireless device. The wireless device can include one or more antennas configured to communicate with a node or transmission station, such as a base station (BS), an evolved Node B (eNB), a baseband unit (BBU), a remote radio head (RRH), a remote radio equipment (RRE), a relay station (RS), a radio equipment (RE), a remote radio unit (RRU), a central processing module (CPM), or other type of wireless wide area network (WWAN) access point. The wireless device can be configured to communicate using at least one wireless communication standard including 3GPP LTE, WiMAX, High Speed Packet Access (HSPA), Bluetooth, and WiFi. The wireless device can communicate using separate antennas for each wireless communication standard or shared antennas for multiple wireless communication standards. The wireless device can communicate in a wireless local area network (WLAN), a wireless personal area network (WPAN), and/or a WWAN.

FIG. 12 also provides an illustration of a microphone and one or more speakers that can be used for audio input and output from the wireless device. The display screen may be a liquid crystal display (LCD) screen, or other type of display screen such as an organic light emitting diode (OLED) display. The display screen can be configured as a touch screen. The touch screen may use capacitive, resistive, or another type of touch screen technology. An application processor and a graphics processor can be coupled to internal memory to provide processing and display capabilities. A non-volatile memory port can also be used to provide data input/output options to a user. The non-volatile memory port may also be used to expand the memory capabilities of the wireless device. A keyboard may be integrated with the wireless device or wirelessly connected to the wireless device to provide additional user input. A virtual keyboard may also be provided using the touch screen.

Various techniques, or certain aspects or portions thereof, may take the form of program code (i.e., instructions) embodied in tangible media, such as floppy diskettes, compact disc-read-only memory (CD-ROMs), hard drives, non-transitory computer readable storage medium, or any other machine-readable storage medium wherein, when the program code is loaded into and executed by a machine, such as a computer, the machine becomes an apparatus for practicing the various techniques. Circuitry can include hardware, firmware, program code, executable code, computer instructions, and/or software. A non-transitory computer readable storage medium can be a computer readable storage medium that does not include signal. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a random-access memory (RAM), erasable programmable read only memory (EPROM), flash drive, optical drive, magnetic hard drive, solid state drive, or other medium for storing electronic data. The node and wireless device may also include a transceiver module (i.e., transceiver), a counter module (i.e., counter), a processing module (i.e., processor), and/or a clock module (i.e., clock) or timer module (i.e., timer). One or more programs that may implement or utilize the various techniques described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

It should be understood that many of the functional units described in this specification have been labeled as modules, in order to more particularly emphasize their implementation independence. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executable of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. The modules may be passive or active, including agents operable to perform desired functions.

Reference throughout this specification to “an example” or “exemplary” means that a particular feature, structure, or characteristic described in connection with the example is included in at least one embodiment of the present invention. Thus, appearances of the phrases “in an example” or the word “exemplary” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof It is understood that such embodiments, examples, and alternatives are not to be construed as defacto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of layouts, distances, network examples, etc., to provide a thorough understanding of embodiments of the invention. One skilled in the relevant art will recognize, however, that the invention can be practiced without one or more of the specific details, or with other methods, components, layouts, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A cellular base station (BS) in a multiple radio access technology (multi-RAT) heterogeneous network (HetNet) that is operable to communicate with a virtual access network (VAN) client, the cellular BS having computer circuitry configured to:
determine a desired VAN server from a plurality of VAN servers for a VAN client to communicate with;
determine a VAN server that the VAN client is in communication with; and
send a VAN server notification to the VAN client when the VAN client is in communication with a different VAN server than the desired VAN server.

2. The computer circuitry of claim 1, wherein the desired VAN server is determined based on a latency or throughput between the cellular BS and a remote VAN server.

3. The computer circuitry of claim 1, wherein the desired VAN server is co-located with the cellular BS.

4. The computer circuitry of claim 1, wherein
the VAN client may be a mobile internet protocol (IP) client, virtual private network (VPN) client; and
the VAN servers may be mobile IP servers, IP home agents, or a VPN server.

5. The computer circuitry of claim 1, wherein the cellular BS is further configured to send the VAN server notification to the VAN client using a radio resource control (RRC) message over a cellular air-interface.

6. The computer circuitry of claim 1, wherein the cellular BS is further configured to send the VAN server notification to the VAN client via the currently serving VAN server using a VAN control message.

7. The computer circuitry of claim 1, wherein the cellular BS is further configured to determine a remote VAN server that the VAN client is in communication with by analyzing a destination internet protocol (IP) address and port number of packets received from a user equipment (UE) on which the VAN client operates.

8. A user equipment (UE) in a multiple radio access technology (multi-RAT) heterogeneous network (HetNet) that is operable to communicate with a virtual access network (VAN) server, the UE having computer circuitry configured to:
operate a VAN client;
receive a VAN server notification at the VAN client from a cellular base station (BS), wherein the VAN server notification identifies a desired VAN server for the VAN client to communicate with; and
determine when to detach from a currently serving VAN server based on data traffic with the cellular BS.

9. The computer circuitry of claim 8, wherein the VAN server notification comprises:
a VAN technology type;
an internet protocol address of the desired VAN server;
a port number or a range of port numbers of the desired VAN server; or a co-location indicator.

10. The computer circuitry of claim 9, wherein the VAN technology type comprises:
a dual stack mobile internet protocol version 6 (DSMIPv6); or
a vendor-specific VAN solution.

11. The computer circuitry of claim 9, wherein the co-location indicator indicates whether the VAN server is co-located with the cellular BS.

12. The computer circuitry of claim 8, wherein the UE is further configured to:
detach from the currently serving VAN server; and
attach to the desired VAN server provided in the VAN server notification.

13. The computer circuitry of claim 9, wherein the computer circuitry is further configured to detach from the currently serving VAN server, with computer circuitry configured to:
send a detachment request to the currently serving VAN server; and
receive a detachment approval from the currently serving VAN server.

14. The computer circuitry of claim 9, wherein the computer circuitry is further configured to attach to the desired VAN server, with computer circuitry configured to:
send an attachment request to the desired VAN server; and
receive an attachment approval from the desired VAN server.

15. A method of switching between frequency bands in a multiple radio access technology (multi-RAT) heterogeneous network (HetNet), the method comprising:
receiving a virtual access network (VAN) absence notification at a user equipment (UE) from a VAN server to identify when a RAN connection for a selected RAT will be unavailable;
moving data traffic operating on the RAN to another RAN; and
moving the data traffic operating on the other RAN back to the RAN when the RAN has switched to a new channel.

16. The method of claim 15, wherein moving data traffic further comprises moving the data traffic operating on the RAN:
from a cellular base station (BS) to another cellular BS;
from the cellular BS to an electrical engineers (IEEE) 802.11-2012, 802.11ac, or 802.11ad configured access point (AP);
from the IEEE 802.11-2012, 802.11ac, or 802.11ad configured AP to the cellular BS; or
from the IEEE 802.11-2012, 802.11ac, or 802.11 ad configured AP to another IEEE 802.11-2012, 802.11ac, or 802.11ad configured AP.

17. The computer circuitry of claim 15, wherein moving data traffic operating on the other RAN to the RAN further comprises:
sending a RAN handover request to the RAN network; and
receiving a RAN handover approval from the RAN network.

18. A virtual access network (VAN) server that is operable to communicate with a VAN client in a multiple radio access technology (multi-RAT) heterogeneous network (HetNet), the VAN server having computer circuitry configured to:
receive a RAN absence notification from a wireless node operating on a selected channel of a radio access network (RAN);
send the RAN absence notification to a VAN client operating on a user equipment (UE); and
detach from a data traffic link between the VAN client and the VAN server.

19. The computer circuitry of claim 18, wherein the computer circuitry is further configured to attach to the data traffic link after the RAN has switched to a new channel.

20. The computer circuitry of claim 18, wherein the computer circuitry is further configured send the RAN absence notification based on an absence indication indicating the absence of a wireless fidelity (Wi-Fi) access point (AP) or a cellular base station (BS).

21. The computer circuitry of claim 18, wherein the computer circuitry is further configured to:
receive a handover request from the VAN client to move data traffic operating on the RAN when a signal interference level exceeds a defined threshold; and
send a handover approval to the VAN client.

22. The computer circuitry of claim 18, wherein the computer circuitry is further configured to:
receive a handover request to move the data traffic back from the other RAN to the RAN when a communication channel on the RAN has switched back to the selected channel; and
send a handover approval to move the data traffic back from the other RAN to the selected channel on the RAN.

23. The computer circuitry of claim 18, wherein the RAN absence notification further comprises:
an absence starting time;
an absence duration;
an absence reason;
a RAN type that will be absent;
a RAN identification (ID) for the RAN that will be absent; or
an operational channel that the RAN will use after switching communication channels.

24. The computer circuitry of claim 23, wherein the RAN ID comprises:
a service set identification (SSID);
a basic service set identification (BSSID); or
a cellular identification (Cell ID).

25. The computer circuitry of claim 23, wherein the absence reason includes channel switching, a hardware update, a firmware update, or a software update.
